(19) United States
(12) Patent Application Publication
(10) Pub. No.: US 2026/0236173 A1
(43) Pub. Date: Aug. 13, 2026

(54) SHARING VOLUME PERFORMANCE BASED ON ORGANIZATION STRUCTURE

(71) Applicant: Hitachi, Ltd., Tokyo (JP)

(72) Inventors: Takanobu SUZUKI, Santa Jose, CA (US); Hiroyuki OSAKI, Los Gatos, CA (US)

(21) Appl. No.: 19/051,982

(22) Filed: Feb. 12, 2025

(51) Int. Cl. G06F 3/06

(52) U.S. Cl. CPC G06F 3/0613; G06F 3/0611; G06F 3/0638; G06F 3/0683

(57) ABSTRACT

Systems and methods described herein can involve sharing storage performance across volumes based on organizational distance. Various embodiments involve analyzing a distance between organizations, represented by the number of hops in an organizational graph, to determine eligibility for performance sharing based on metrics such as throughput and response time. Eligible storage volumes are grouped, and configuration parameters, such as Quality of Service (QoS), are set to optimize performance. The systems and methods support dynamically adjustable criteria, periodic monitoring of storage volumes, and grouping based on organizational units, ensuring efficient resource allocation and performance sharing across storage devices.

### BACKGROUND

### Field

The present disclosure is generally directed to storage system performance optimization, and more specifically, to systems and methods for dynamic performance allocation across storage volumes.

### Related Art

In internal IT infrastructure management, much like in cloud environments, Service Level Objectives (SLOs) and associated costs are typically defined by an IT infrastructure manager, allowing users to select services that meet their specific needs. A major challenge in such applications is the underutilization of hardware resources, which is caused by the difficulty of predicting IT infrastructure demand. Oftentimes, this leads to scenarios where storage volumes are either underutilized or overloaded. The resulting inefficiencies are particularly common in non-production environments, such as development and testing systems, where system resources may remain largely idle, thus increasing operational costs.

Current systems lack effective mechanisms for dynamically reallocating unused storage resources between volumes, particularly in scenarios where different divisions or teams manage separate resources. For example, in a company with multiple divisions, one division may have storage resources that are underutilized, while another division may experience performance shortages. Existing approaches do not ensure that volume performance can be efficiently shared across organizational boundaries. Even if a volume owner capable of sharing resources has been identified, performance sharing may not be feasible due to technical constraints, such as volumes residing on different storage devices, and the like.

Accordingly, it is desirable to have systems and methods that enable dynamic performance allocation across storage volumes. Therefore, systems and methods herein leverage organizational structure and real-time performance metrics to optimize hardware utilization. In embodiments, this is accomplished by analyzing the proximity of organizations within an internal hierarchy, where a system identifies volumes that can share performance and automatically creates Quality of Service (QoS) groups such as to allow closer organizational units to share resources, thereby reducing underutilization and improving overall hardware efficiency without compromising service levels.

### SUMMARY

In some aspects of the disclosure, a method for sharing storage performance across volumes based on organizational distance may comprise: analyzing a distance between a first organization and a second organization, the distance being represented by a number of hops between the first organization and the second organization, which may be determined from an organizational graph; determining whether a storage volume is eligible for performance sharing based on dynamically adjustable performance metrics comparison the distance, a throughput, a response time, or a throughput limit; in response to the storage volume being eligible for performance sharing, assigning the storage volume to a group of storage volumes, e.g., a QoS group that may be prioritized based on the performance metrics; and setting one or more configuration parameters for the group of storage volumes based on a relationship between at least two storage volumes within the group of storage volumes, which may be defined by a sum of throughput limits of the at least two storage volumes.

In some aspects, determining whether the storage volume is eligible for performance sharing may comprise identifying the at least two storage volumes and corresponding performance metrics, wherein each storage volume is associated with an organizational structure, which comprises an organization ID, a parent organization ID, or a distance from each organization to a storage device. The organizational structure may be retrieved from a directory server that includes at least one of LDAP or active directory.

In some aspects, may further comprise, for each storage volume, defining a throughput upper limit, and setting the throughput upper limit of each volume to a value that enables performance sharing when forming the group, wherein setting the one or more configuration parameters may comprise adjusting QoS configurations in a management table to enable performance sharing among the volumes.

In some aspects, may further comprise (1) monitoring storage devices to determine associated storage volumes that exceed their throughput or capacity thresholds, and prioritizing storage volumes that exceed their throughput upper limit for grouping; (2) selecting a storage device for creating a new storage volume based on performance and capacity thresholds for the storage device, wherein the throughput or capacity thresholds are stored in a storage device management table; (3) in response to the storage volume exceeding its performance threshold, suggesting a potential group for performance sharing; (4) using a management UI to manually modify the group of storage volumes to include or exclude specific storage volumes; and/or (5) grouping storage volumes for performance sharing if the volumes are owned by a same organizational unit, as specified in an organizational management table.

In some aspects, the storage volumes belonging to the same organizational unit or division are prioritized for inclusion in a same QoS group, and the storage devices may be sorted based on their proximity to an organization associated with the storage volume being created, using distance data from a user management table.

In some aspects, storage volumes may be automatically removed from the group of storage volumes if their performance metrics remain below predefined thresholds.

Some aspects described herein relate to a non-transitory computer-readable medium for storing instructions for executing a process, comprising: analyzing a distance between a first organization and a second organization, the distance being represented by a number of hops between the first organization and the second organization; determining whether a storage volume is eligible for performance sharing based on one or more performance metrics including at least one of the distance, a throughput, a response time, or a throughput limit; in response to the storage volume being eligible for performance sharing, assigning the storage volume to a group of storage volumes; and setting one or more configuration parameters for the group of storage volumes based on a relationship between at least two storage volumes within the group of storage volumes.

Some aspects described herein relate to an apparatus comprising: a processor, configured to: analyze a distance between a first organization and a second organization, the distance being represented by a number of hops between the first organization and the second organization; determine whether a storage volume is eligible for performance sharing based on one or more performance metrics including at least one of the distance, a throughput, a response time, or a throughput limit; in response to the storage volume being eligible for performance sharing, assign the storage volume to a group of storage volumes; and set one or more configuration parameters for the group of storage volumes based on a relationship between at least two storage volumes within the group of storage volumes.

Aspects of the present disclosure can involve means for analyzing a distance between a first organization and a second organization, wherein the distance may be represented by a number of hops between the first organization and the second organization.

Aspects of the present disclosure can involve means for determining whether a storage volume is eligible for performance sharing based on one or more performance metrics including at least one of the distance, a throughput, a response time, or a throughput limit; in response to the storage volume being eligible for performance sharing, assigning the storage volume to a group of storage volumes.,

Aspects of the present disclosure can involve means for setting one or more configuration parameters for the group of storage volumes based on a relationship between at least two storage volumes within the group of storage volumes.

### BRIEF DESCRIPTION OF DRAWINGS

FIG. 1 illustrates a storage system for sharing volume performance based on organizational structure, according to various embodiments of the present disclosure.

FIG. 2 illustrates details of the storage management service and associated storage management tables shown in FIG. 1.

FIG. 3 is a use case diagram illustrating interactions between a storage administrator and a storage user within a storage system, such as that shown in FIG. 1, according to various embodiments of the present disclosure.

FIG. 4 illustrates a service catalogue setting user interface (UI), according to various embodiments of the present disclosure.

FIG. 5 illustrates a resource information registration UI according to various embodiments of the present disclosure.

FIG. 6 illustrates a performance share configuration UI according to various embodiments of the present disclosure.

FIG. 7 illustrates the volume creation UI, according to various embodiments of the present disclosure.

FIG. 8 depicts local storage management tables, according to various embodiments of the present disclosure.

FIG. 9 illustrates volume management and organization management tables, according to various embodiments of the present disclosure.

FIG. 10 depicts tables used to manage performance metrics of volumes, according to various embodiments of the present disclosure.

FIG. 11 is a flowchart illustrating a process for volume creation according to various embodiments of the present disclosure.

FIG. 12 is a flowchart illustrating a process following volume creation in a storage management service, according to various embodiments of the present disclosure.

FIG. 13 is a flowchart illustrating a process following a performance share configuration, according to various embodiments of the present disclosure.

FIG. 14 is a flowchart illustrating a process for creating a new QoS group in the storage management service, according to various embodiments of the present disclosure.

FIG. 15 is a flowchart illustrating a process for periodic checks of performance sharing in a storage management service, according to various embodiments of the present disclosure.

FIG. 16 is a flowchart illustrating a process for storage management service when a user updates a volume policy, according to various embodiments of the present disclosure.

FIG. 17 is a flowchart illustrating a process for storage management service when a user deletes a volume.

FIG. 18 illustrates an example computing environment with an example computing device, according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

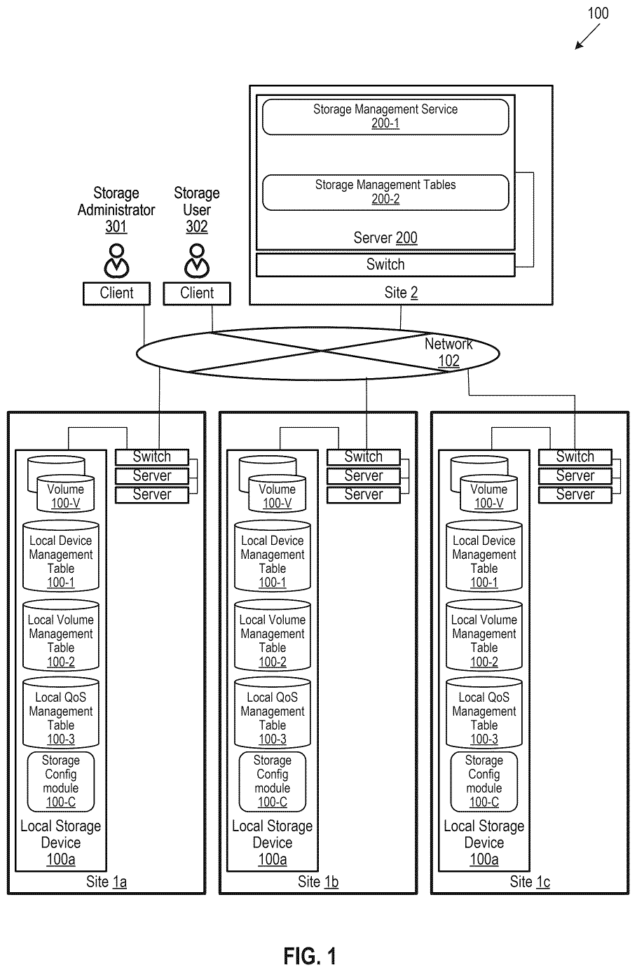

FIG. 1 illustrates a storage system for sharing volume performance based on organizational structure, according to various embodiments of the present disclosure. In embodiments, storage system 100 comprises sites 1a, 1b, 1c, and 2, which are communicatively coupled to one another via network 102, such as the internet or a wide area network (WAN). Storage system 100 is managed by storage administrator 301 and storage user 302, who operate storage services across sites 1a, 1b, 1c, and 2. As depicted, site 2 comprises storage management service 200-1 and storage management tables 200-2, which are communicatively coupled to manage and monitor storage services for other sites. In embodiments, sites 1a, 1b, and 1c each may comprise any number of servers and switches and local storage devices 100a, which are coupled via a local area network (LAN) or a storage area network (SAN). The servers, which run virtual machines, containers, and applications, are communicatively coupled to local storage device 100a for data storage. Each storage device 100a may be coupled to a storage configuration module 100-C, which manages the configuration of any number of devices and volumes (e.g., 100-V). As depicted, each storage device 100a may further comprise local device management table 100-1, which stores device information such as ID, address, and capacity; local volume management table 100-2, which stores volume information such as ID and capacity; and local QoS management table 100-3, which stores QoS configurations, such as volume IDs, throughput upper limits, and throughput lower limits.

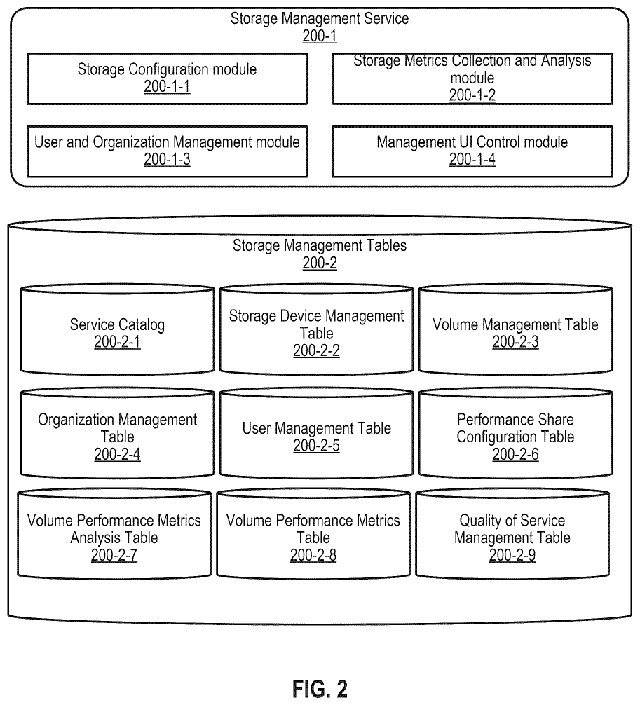

FIG. 2 illustrates details of the storage management service and associated storage management tables shown in FIG. 1. As depicted in FIG. 2, storage management service 200-1 comprises storage configuration module 200-1-1, storage metrics collection and analysis module 200-1-2, user and organization management module 200-1-3, and management UI control module 200-1-4. In embodiments, storage management service 200-1 may be implemented as or comprise resource monitoring and prediction modules (not shown). Storage management tables 200-2, which may be communicatively coupled to or accessible by various storage devices, may comprise service catalogue 200-2-1; storage device management table 200-2-2; volume management table 200-2-3; organization management table 200-2-4; and user management table 200-2-5.

In operation, storage configuration module 200-1-1 manages the configuration of storage devices, including the creation, modification, and deletion of volumes of storage devices, as well as the setting of QoS parameters. Storage metrics collection and analysis module 200-1-2 may couple to the storage devices via the network (102) to collect performance data, such as throughput, latency, and used capacity. Storage metrics collection and analysis module 200-1-2 processes this data for statistical analysis, calculating averages, maximums, and minimums. User and organization management module 200-1-3 is coupled to external directory services, such as LDAP or Active Directory, or receives manual input from administrators, to manage user and organizational data. This module also determines the organizational proximity required for performance sharing. Management UI control module 200-1-4 is communicatively coupled to storage administrator 301 and storage user 302 to provide a graphical user interface for interacting with the system, allowing for performance monitoring and storage configuration adjustments.

Service catalogue 200-2-1 comprises a list of volume services available to users, including unit prices, capacity, and throughput limits. Storage device management table 200-2-2 stores information such as device ID, location, address, capacity, and performance thresholds. Volume management table 200-2-3 comprises data on volumes, including volume ID, capacity, performance metrics (e.g., throughput and response time), and the associated organization. Organization management table 200-2-4 is coupled to the user management system and comprises hierarchical information about organizations, allowing the system to calculate organizational proximity for performance sharing. User management table 200-2-5 comprises user data, including user ID, organizational affiliation, and the calculated distance between the user's organization and the representative storage device's organization. Performance share configuration table 200-2-6 comprises settings for performance sharing, such as distance thresholds and the time range for metric collection. Volume performance metrics analysis table 200-2-7 comprises statistical data derived from raw performance metrics, which are used to assess which volumes can share or need performance adjustments, while volume performance metrics table 200-2-8 stores raw performance metrics such as throughput and response times. Finally, QoS management table 200-2-9, which is accessible by volumes and devices, comprises information on QoS settings, including QoS group IDs, associated volume IDs, and throughput upper and lower limits.

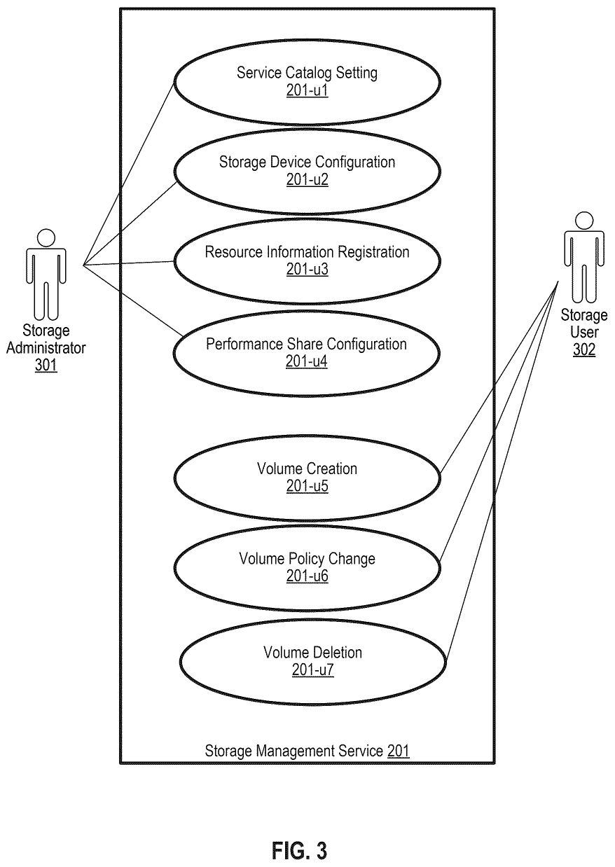

FIG. 3 is a use case diagram illustrating interactions between a storage administrator and a storage user within a storage system, such as that shown in FIG. 1, according to various embodiments of the present disclosure. In embodiments, storage administrator 301 may access storage devices and storage management service 201 to perform various tasks. Such tasks may comprise service catalogue setting 201-u1, which allows the administrator to define and update volume services as needed; storage device configuration 201-u2, which involves managing the installation and configuration of storage devices; resource information registration 201-u3, which allows the administrator to register available servers and storage devices; and performance share configuration 201-u4, which allows the administrator to set the rules and parameters for performance sharing between volumes.

Conversely, storage user 302 accesses the storage system to create volumes 201-u5, change policies 201-u6, and/or delete volumes 201-u7, thereby specifying volume type, capacity, and performance requirements through this interface.

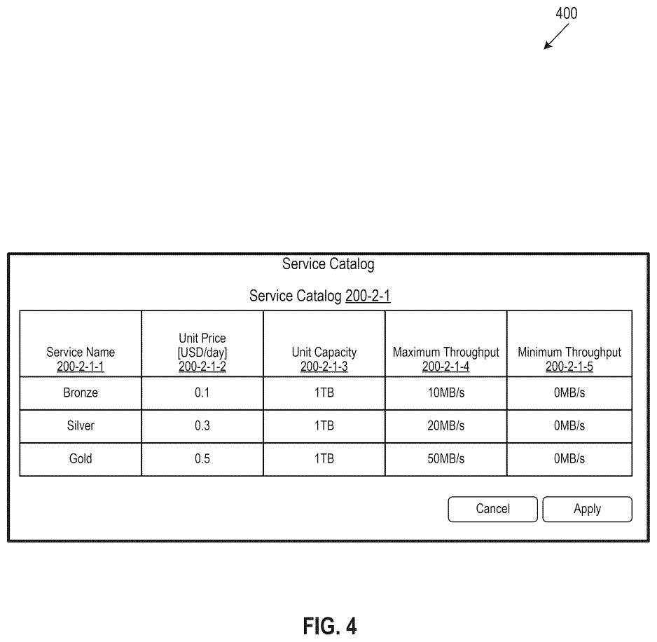

FIG. 4 illustrates a service catalogue setting UI, according to various embodiments of the present disclosure. In embodiments, service catalogue setting UI 400 is displayed for a storage administrator, who communicatively couples to the storage management system and storage devices. Through this interface, the storage administrator may configure storage services and define parameters stored within service catalogue 200-2-1. Configurable parameters comprise service name 200-2-1-1, which serves as a unique identifier for each service; unit price 200-2-1-2, which specifies the cost per unit of storage; unit capacity 200-2-1-3, which indicates the amount of storage capacity provided by the service; maximum throughput 200-2-1-4, which represents the maximum performance guaranteed by the service; and minimum throughput 200-2-1-5, which defines the minimum performance guaranteed by the service. Once so defined, these service parameters are stored in service catalogue 200-2-1 and made available to the storage user, e.g., upon the user initiating a process of creating new volumes within the system.

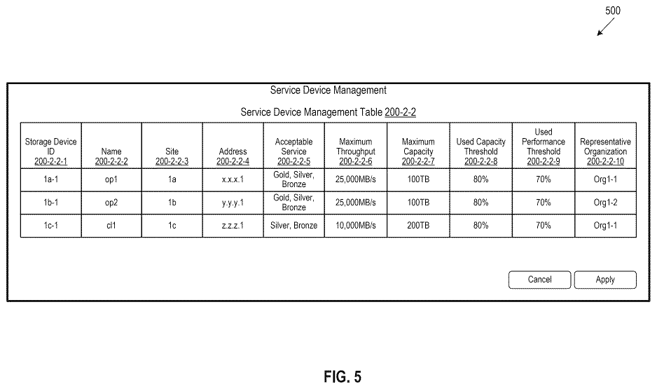

FIG. 5 illustrates a resource information registration UI according to various embodiments of the present disclosure. In embodiments, UI 500 is displayed by the storage management service (200-1) to storage administrator (301) for resource information registration (201-u3). The screen displays information stored in storage device management table 200-2-2 and accepts edits from the administrator (301). In embodiments, UI 500 allows the storage administrator to register and manage storage devices by inputting key device parameters and thresholds. Storage device management table 200-2-2 manages a list of storage devices tied to storage device IDs 200-2-2-1, and includes parameters such as: storage device ID 200-2-2-1, a unique identifier for each storage device in the system; name 200-2-2-2, a unique name assigned to each storage device; site 200-2-2-3, the site name where the storage device is located; address 200-2-2-4, a unique address, such as an IP address or DNS name, for the storage device; acceptable service 200-2-2-5:, a set of service classes acceptable at the storage device defined in service catalogue 200-2-1; maximum throughput 200-2-2-6, the maximum throughput that can be provided by the storage device; maximum capacity 200-2-2-7, the maximum usable capacity of the storage device; used capacity threshold 200-2-2-8, the percentage of total capacity that, when exceeded, triggers an alert to the storage administrator; used performance threshold 200-2-2-9, the percentage of total performance utilization that, when exceeded, triggers an alert to the storage administrator; and representative organization 200-2-2-10, the organization used when calculating the distance between the storage device and other organizations for performance sharing purposes.

By using UI 500, the storage administrator can efficiently manage storage devices, ensuring they are properly configured and monitored. The interface provides real-time alerts when set thresholds—such as used capacity or performance thresholds—are exceeded, allowing the administrator to take timely action to maintain optimal system performance.

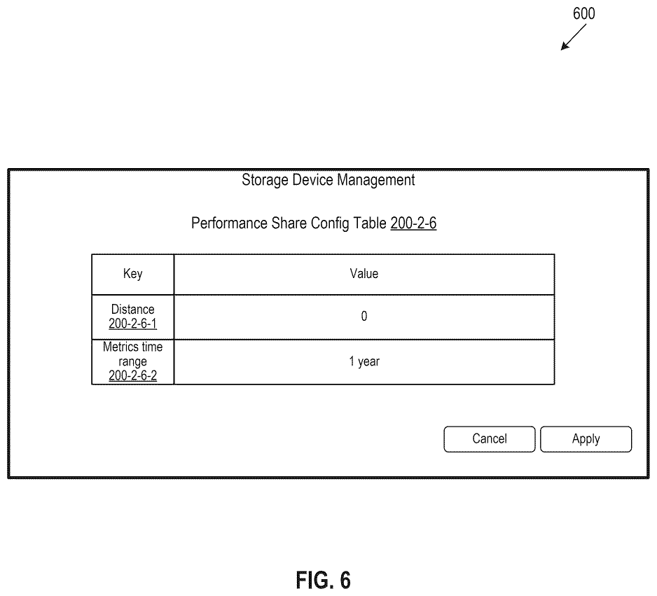

FIG. 6 illustrates a performance share configuration UI according to various embodiments of the present disclosure. In embodiments, a storage administrator may use UI 600 to configure parameters for sharing performance between volumes. Interface 600 is communicatively coupled to the performance share configuration table 200-2-6, which stores the relevant configuration parameters for performance sharing. Example parameters include distance threshold 200-2-6-1, which sets the maximum allowable proximity between organizations for volumes to qualify for performance sharing, and metric time range 200-2-6-2, which defines the period over which performance metrics are assessed to determine the necessity of performance sharing. Once configured, the settings may be stored in performance share configuration table 200-2-6 and applied to the storage devices to optimize performance across the system.

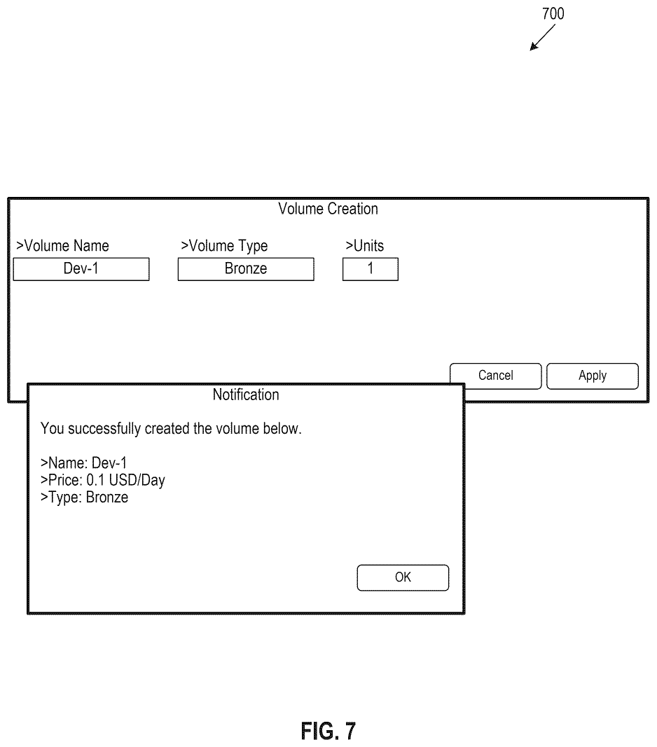

FIG. 7 illustrates the volume creation UI, according to various embodiments of the present disclosure. Interface 700 is communicatively coupled to both the volume management table 200-2-3 and service catalogue 200-2-1. In embodiments, a storage user may create and configure new storage volumes. The storage users may employ UI 700 to define parameters for the new volume, including the volume type, which determines the storage type (e.g., block or object storage); a capacity, which specifies the amount of storage required; and a throughput, allowing the user to set both maximum and minimum performance levels. Once the volume is created, the system automatically updates the volume management table 200-2-3 with the volume's details, including its capacity and throughput specifications, and stores this data for future reference and management.

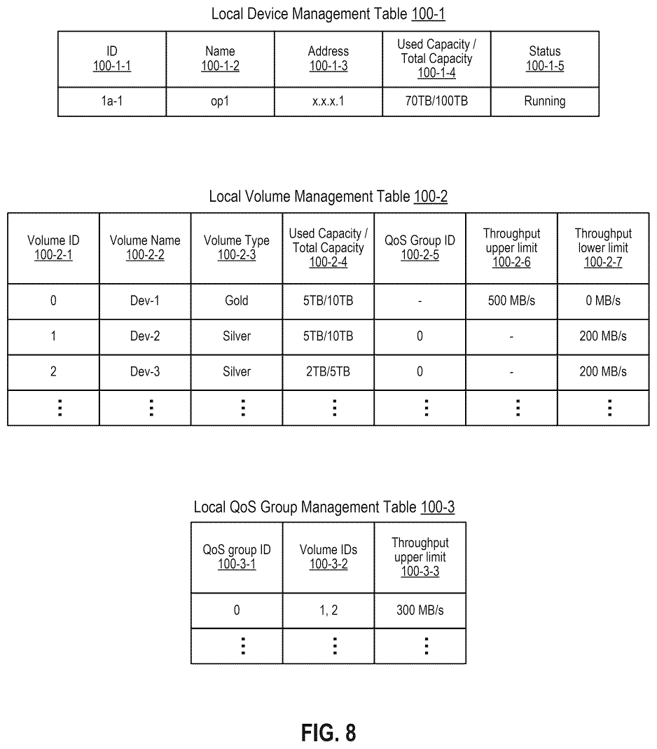

FIG. 8 depicts local storage management tables, according to various embodiments of the present disclosure. Depicted are local device management table 100-1, local volume management table 100-2, and local QoS management table 100-3. In embodiments, these tables are accessible by local storage device 100a to ensure that configuration and performance data are managed at the local level. Local device management table 100-1 may store information about a storage device, such as device ID 100-1-1, address 100-1-3, and used and total capacity 100-1-4. Local volume management table 100-2 may store details about each volume, such as volume ID 100-2-1, volume type 100-2-3, capacity 100-2-4, and the associated QoS settings 100-2-5. Local QoS management table 100-3 may track the QoS configuration for each volume, including throughput upper and lower limits 100-3-3 as well as volume IDs 100-3-2. In this manner, the tables enable management of device and volume configurations, which further aids in optimizing local storage performance.

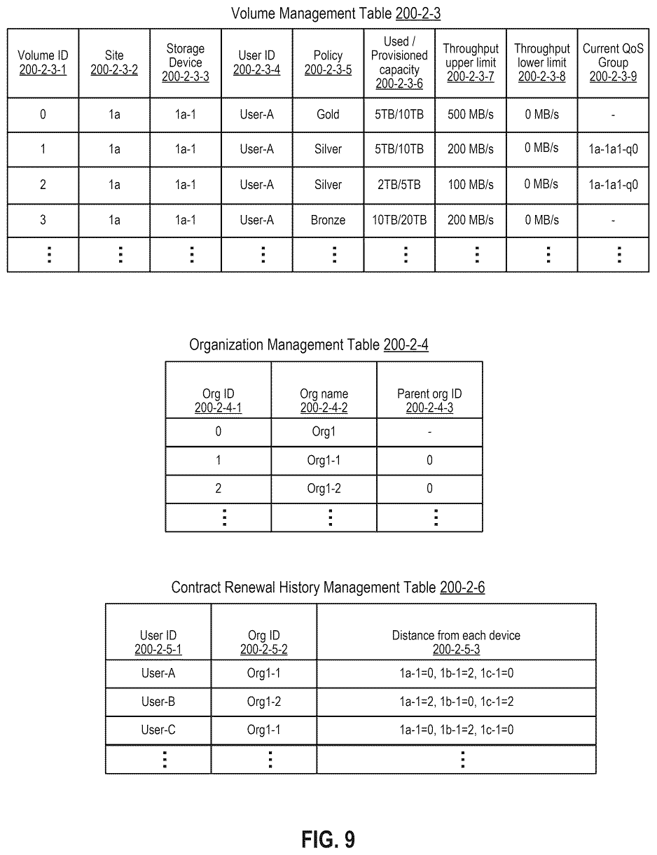

FIG. 9 illustrates volume management and organization management tables, according to various embodiments of the present disclosure. In embodiments, volume management table 200-2-3, organization management table 200-2-4, and user organization management table 200-2-5 are communicatively coupled to the storage management system. Volume management table 200-2-3 stores details about each volume, including volume ID 200-2-3-1, site 200-2-3-2, associated storage device 200-2-3-3, policy 200-2-3-5, capacity 200-2-3-6, throughput limits (e.g., 200-2-3-7), and current QoS group 200-2-3-9. Volume management table 200-2-3 ensures that volume-related data is readily accessible for monitoring and management purposes.

Organization management table 200-2-4 stores the hierarchical structure of organizations within a system, such as organization identifiers 200-2-4-1, organization name 200-2-4-2, and parent organization identifiers 200-2-4-3. The organizational structure allows the system calculate proximity between different organizations, an important factor in determining whether volumes managed by those organizations can share performance resources. By leveraging proximity data, the system can thus optimize resource allocation and facilitate performance sharing between volumes to ensure efficient usage of storage resources across the system.

User management table 200-2-5 stores information of all users 302, including user ID 200-2-5-1, organization ID 200-2-5-2, and distance from each device 200-2-5-3, i.e., the distance between the organization of the user and the representative organization of the storage device. The distance may be defined as the number of smallest hop count from one organization to another.

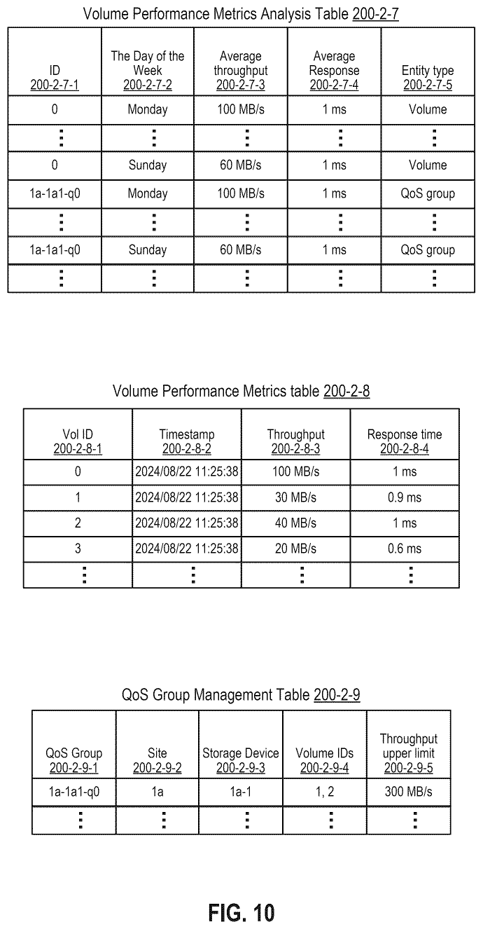

FIG. 10 depicts tables used to manage performance metrics of volumes, according to various embodiments of the present disclosure. In embodiments, volume performance metrics table 200-2-8 and volume performance metrics analysis table 200-2-7 are communicatively coupled to the storage management system and to storage devices. Volume performance metrics analysis table 200-2-7 stores statistical values derived from the raw performance data stored in volume performance metrics table 200-2-8. This analysis includes information such as Volume ID 200-2-7-1, day of the week 200-2-7-2, average throughput 200-2-7-3, average response time 200-2-7-4, and entity type 200-2-7-5. Volume ID 200-2-7-1 corresponds to either a specific volume ID or a QoS group ID. The day of the week 200-2-7-2 is used as a key for calculating statistical values such as averages, maximums, and minimums. However, the use of the day of the week is not limited to this particular embodiment, and other grouping keys may be used.

Volume performance metrics table 200-2-8 stores raw performance metrics for each volume, including volume ID 200-2-8-1, timestamp 200-2-8-2, throughput 200-2-8-3, and response time 200-2-8-4. In embodiments, volume performance metrics table 200-2-8 may be periodically updated by the storage metrics collection and analysis module (200-1-2) to ensure up-to-date performance tracking.

Additionally, QoS group management table 200-2-9 stores data related to QoS groups, including QoS group ID 200-2-9-1, site 200-2-9-2, storage device 200-2-9-3, volume IDs 200-2-9-4, and throughput upper limits 200-2-9-5. Each QoS group is identified by a unique QoS group ID, and throughput upper limit 200-2-9-5 represents the maximum throughput allowed for the entire QoS group, which includes the associated volume IDs.

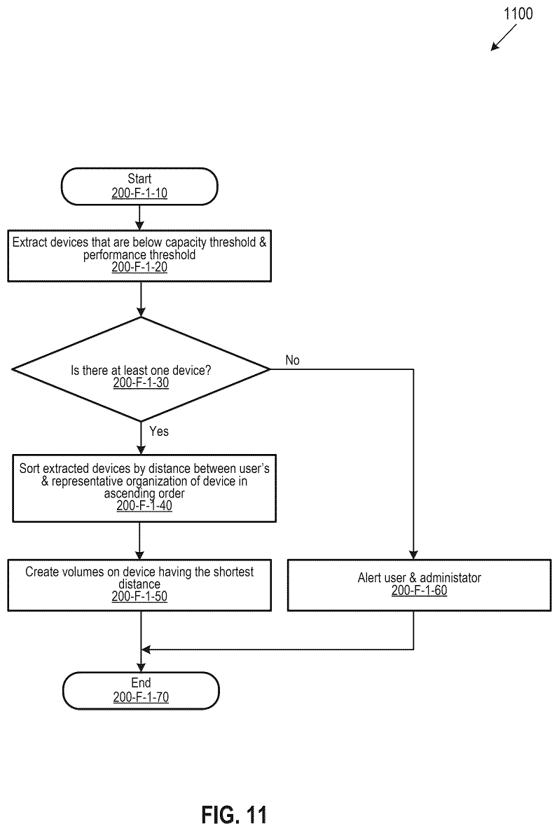

FIG. 11 is a flowchart illustrating a process for volume creation according to various embodiments of the present disclosure. In embodiments, process 1100 starts at step 200-F-1-10, when the volume creation is invoked by the storage management service (200-1), e.g., in response to receiving a volume creation request from a user (302).

At step 200-F-1-20, the system identifies storage devices that use less capacity and performance than a threshold, e.g., by using data from the storage device management table (200-2-2).

At step 200-F-1-30, the system determines whether at least one storage device is available. If so, at step 200-F-1-40, the system uses the organization management table (200-2-4) to sort identified devices by distance between the user's organization and the representative organization of each device.

At step 200-F-1-50, the system creates volumes on the device having the shortest distance, and process 1100 ends at step 200-F-1-70.

If, at step 200-F-1-30, the system determines no device meets the capacity and performance thresholds, then, at step 200-F-1-60, the system alerts the user and the storage administrator, indicating that no devices have sufficient capacity and performance to accept the new volume before process 1100 ends at step 200-F-1-70.

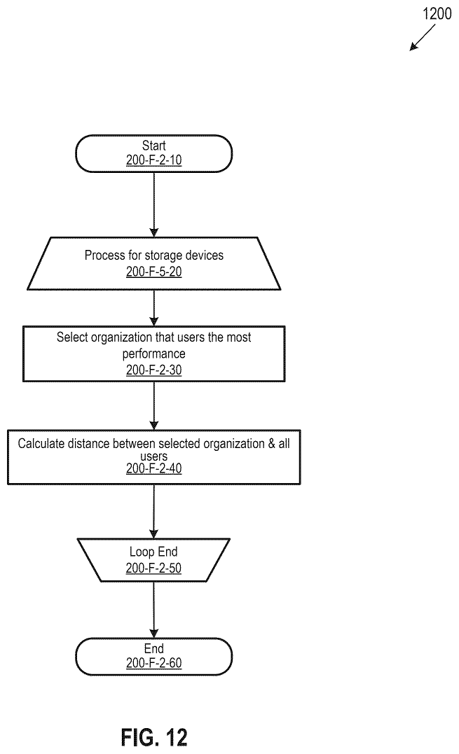

FIG. 12 is a flowchart illustrating a process following volume creation in a storage management service, according to various embodiments of the present disclosure. In embodiments, process 1200 starts at step 200-F-2-10, either after volume creation or during periodic system checks, e.g., based on a predetermined schedule.

At step 200-F-2-20, the system may loop through any number of storage devices to select, at step 200-F-2-30, the organization that uses the most performance, based on data from the volume management table (200-2-3) and organization management table (200-2-4).

At step 200-F-2-40, the system calculates a distance between the selected organization and each user.

Once the loop through all devices has been completed, at step 200-F-2-50, process 1200 ends at step 200-F-2-60.

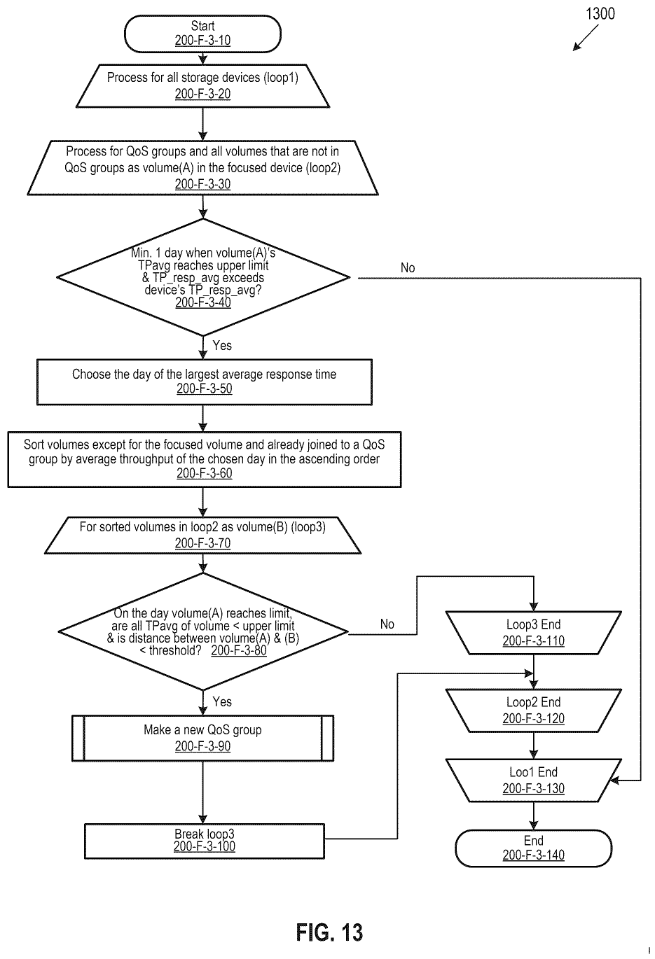

FIG. 13 is a flowchart illustrating a process following a performance share configuration, according to various embodiments of the present disclosure.

At step 200-F-3-10, the process 1300 is automatically invoked, e.g., periodically or after the completion of the performance share configuration (201-u4) illustrated in FIG. 3.

At step 200-F-3-20, the system, in a first loop, loops through all storage devices.

At step 200-F-3-30, the system, in a second loop, loops through all QoS groups and volumes that are not already part of a QoS group.

At step 200-F-3-40, the system determines whether there is at least one weekday where the volume's average throughput reaches its upper limit and the average response time exceeds the device's average response time, using data from the volume performance metrics analysis table (200-2-7).

If so, the system selects, at step 200-F-3-50, the day with the highest average response time for the given volume.

At step 200-F-3-60, the system sorts all other volumes by average throughput on that day in ascending order.

At step 200-F-3-70, the system, in a third loop, loops through the sorted volumes to identify volumes that can share resources.

At step 200-F-3-80, the system determines whether all average throughputs for the selected volume on the day that volume A reaches its upper limit are below its maximum throughput. Additionally, the system calculates whether the distance between volume A and volume B is less than or equal to the defined threshold by using data from the volume performance metrics analysis table (200-2-7) and the performance share configuration table (200-2-6).

As an example, assuming two volumes, volume A and volume B, volume A's average throughput being 100 MB/s, and its maximum throughput being as defined by contract as 200 MB/s, and volume B's average throughput being 200 MB/s, with a contract-defined maximum throughput of 200 MB/s, both volumes being owned by the same organization, the distance threshold is set to 0, i.e., volumes owned by the same organization are eligible for performance sharing. As a result, a new QoS group may be created that includes both volume A and volume B. If volume A is part of an existing QoS group, the system may verify that all volumes within that group meet the distance threshold criteria.

At step 200-F-3-90, the system creates a new QoS group that includes volume A and volume B that meet the performance and proximity requirements.

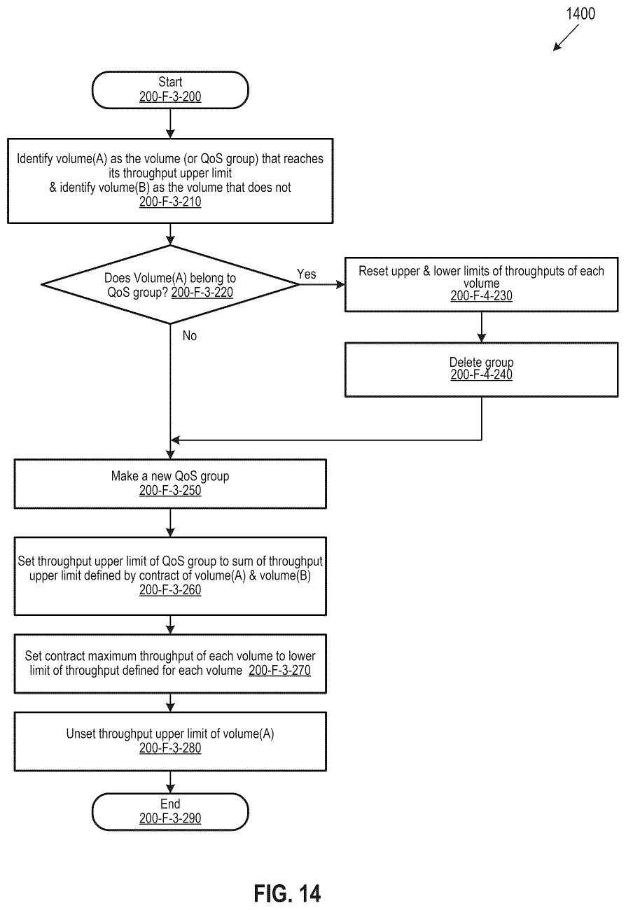

FIG. 14 is a flowchart illustrating a process for creating a new QoS group in the storage management service, according to various embodiments of the present disclosure. At step 200-F-3-200, process 1400 may be automatically triggered, e.g., by step 200-F-3-90 (shown in FIG. 13).

At step 200-F-3-210, the system identifies volume A as the volume (or QoS group) that has reached its throughput upper limit, and volume B as the volume that has not yet reached its throughput upper limit.

At step 200-F-3-220, the system determines whether volume A is an existing QoS group. If so, process 1400 resumes with step 200-F-3-230, where the system resets the upper limit of throughput for both volumes to the maximum throughput defined by their respective contracts. Then, at step 200-F-3-240, the system deletes the existing QoS group.

If not, process 1400 continues, at step 200-F-3-250, by the system creating a new QoS group.

At step 200-F-3-260, the system sets the upper throughput limit of the new QoS group to the sum of the upper limits defined by the contracts for volume A and volume B. At step 200-F-3-270, the system sets the contract maximum throughput of each volume to the lower limit of throughput defined for each volume.

Finally, at step 200-F-3-280, the system removes the throughput upper limit for volume A.

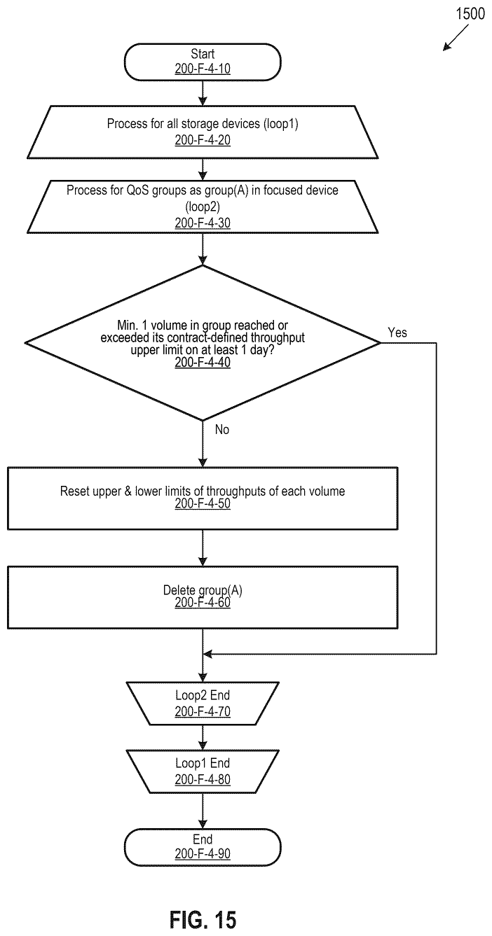

FIG. 15 is a flowchart illustrating a process for periodic checks of performance sharing in a storage management service, according to various embodiments of the present disclosure. Process 1500 may be automatically triggered, at step 200-F-4-10, e.g., after performance share configuration 201-u4 is completed or periodically.

At step 200-F-4-20, the system loops through all storage devices.

At step 200-F-4-30, the system loops through all QoS groups within the device being processed.

At step 200-F-4-40, the system determines whether any volumes in the group have reached or exceeded their contract-defined throughput upper limit on at least one day. If no volume has reached the upper limit, at step 200-F-4-50, the system dissolves the QoS group and resets the throughput upper and lower limits for each volume.

At step 200-F-4-60, group A is deleted, and process 1500 and all loops end.

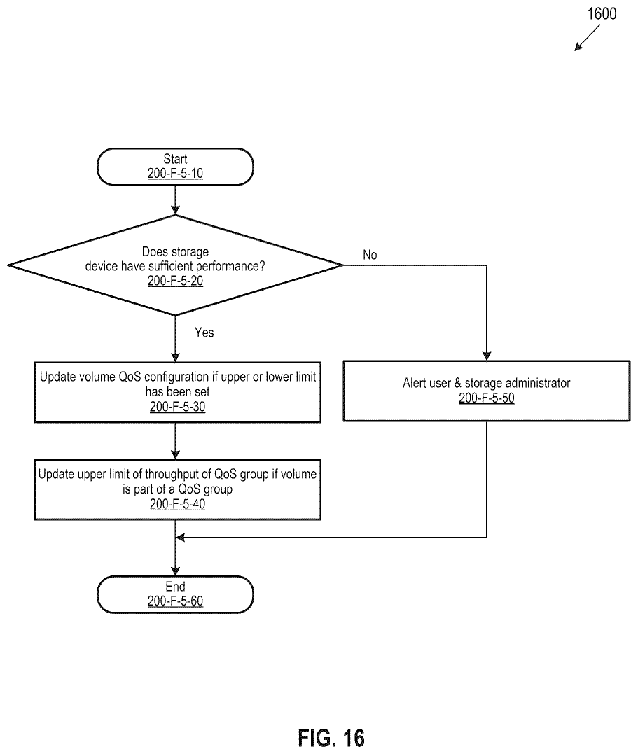

FIG. 16 is a flowchart illustrating a process for storage management service when a user updates a volume policy, according to various embodiments of the present disclosure.

Process 1600 may be automatically triggered, at step 200-F-5-10, e.g., when a user updates the volume policy.

At step 200-F-5-20, the system determines whether the storage device has sufficient performance capacity to support the updated policy.

At step 200-F-5-30, the system updates the volume's QoS configuration with the new throughput limits. If the volume belongs to a QoS group, at step 200-F-5-40, the system updates the throughput upper limit for the entire group, and process 1600 ends at step 200-F-5-60.

At step 200-F-5-50, the system alerts the user and the storage administrator of the changes, and process 1600 ends at step 200-F-5-60.

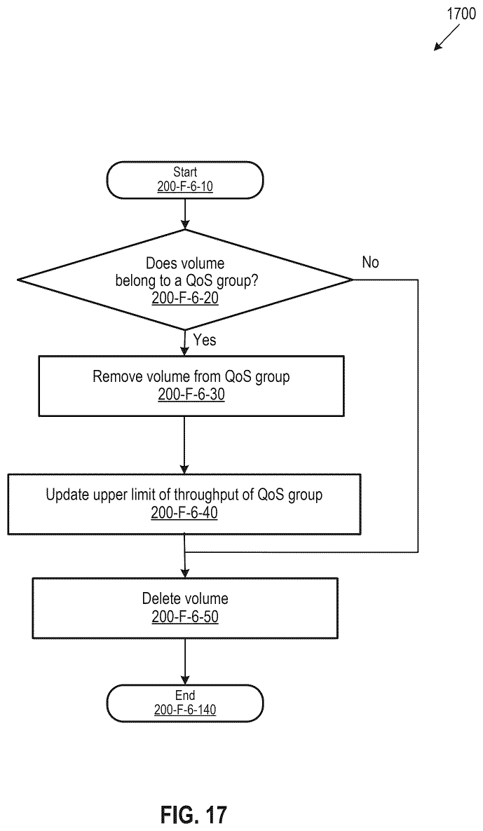

FIG. 17 is a flowchart illustrating a process for storage management service when a user deletes a volume.

Process 1700 may be automatically triggered, at step 200-F-6-10, when a user deletes the volume in 201-u7.

At step 200-F-6-20, the system determines whether the volume belongs to a QoS group.

If so, at step 200-F-6-30, the system updates the QoS group's throughput upper limit.

At step 200-F-6-40, the system removes the volume from the QoS group.

At step 200-F-6-50, the system deletes the volume from the storage system.

If at step 200-F-6-20, the system determines that the volume does not belong to a QoS group, process 1700 resumes with step 200-F-6-50 and ends at step 200-F-6-140.

One skilled in the art shall recognize that: (1) certain steps may optionally be performed; (2) steps may not be limited to the specific order set forth herein; (3) certain steps may be performed in different orders; and (4) certain steps may be done concurrently.

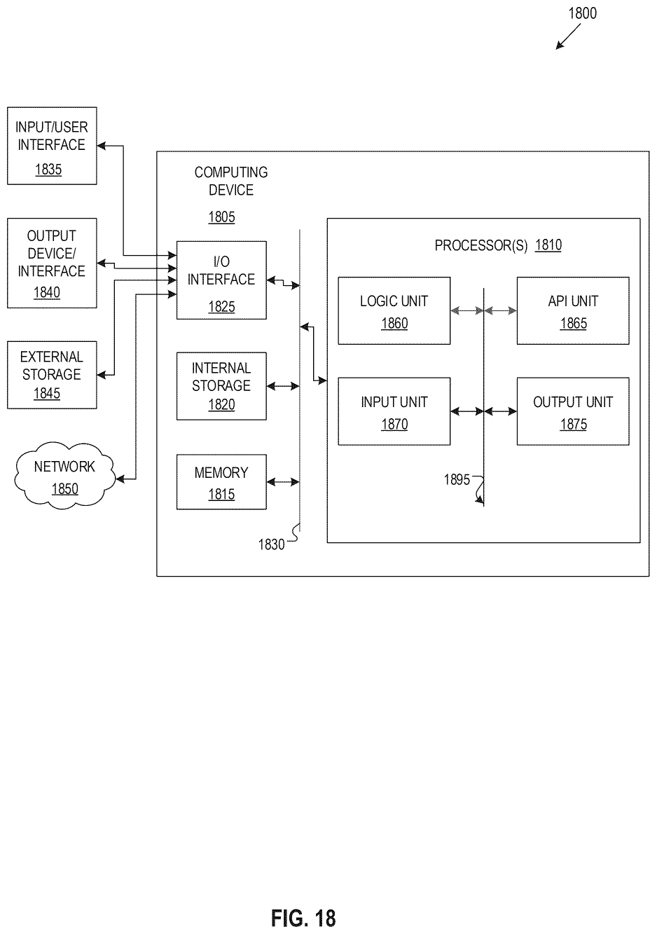

FIG. 18 illustrates an example computing environment with an example computing device suitable for use in some example implementations, according to various embodiments of the present disclosure. Computing device 1805 in computing environment 1800 can include one or more processing units, cores, or processors 1810, memory 1815 (e.g., RAM, ROM, and/or the like), internal storage 1820 (e.g., magnetic, optical, solid-state storage, and/or organic), and/or I/O interface 1825, any of which can be coupled on a communication mechanism or bus 1830 for communicating information or embedded in the computing device 1805. I/O interface 1825 is also configured to receive images from cameras or provide images to projectors or displays, depending on the desired implementation.

Computing device 1805 can be communicatively coupled to input/user interface 1835 and output device/interface 1840. Either one or both of input/user interface 1835 and output device/interface 1840 can be a wired or wireless interface and can be detachable. Input/user interface 1835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1840 may include a display, television, monitor, printer, speaker, braille, or the like. In some example implementations, input/user interface 1835 and output device/interface 1840 can be embedded with or physically coupled to the computing device 1805. In other example implementations, other computing devices may function as or provide the functions of input/user interface 1835 and output device/interface 1840 for a computing device 1805.

Examples of computing device 1805 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 1805 can be communicatively coupled (e.g., via I/O interface 1825) to external storage 1845 and network 1850 for communicating with any number of networked components, devices, and systems, including one or more computing devices of the same or different configurations. Computing device 1805 or any connected computing device can be functioning as, providing services of, or referred to as a server, client, thin server, general machine, special-purpose machine, or another label.

I/O interface 1825 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1800. Network 1850 can be any network or combination of networks (e.g., the Internet, local area network, wide area network, a telephonic network, a cellular network, a satellite network, and the like).

Computing device 1805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computing device 1805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1810 can execute under any operating system (OS) (not shown), in a native or virtual environment. One or more applications can be deployed that include logic unit 1860, application programming interface (API) unit 1865, input unit 1870, output unit 1875, and inter-unit communication mechanism 1895 for the different units to communicate with each other, with the OS, and with other applications (not shown). The described units and elements can be varied in design, function, configuration, or implementation and are not limited to the descriptions provided. Processor(s) 1810 can be in the form of hardware processors such as central processing units (CPUs) or a combination of hardware and software units.

In some example implementations, when information or an execution instruction is received by API unit 1865, it may be communicated to one or more other units (e.g., logic unit 1860, input unit 1870, output unit 1875). In some instances, logic unit 1860 may be configured to control the information flow among the units and direct the services provided by API unit 1865, input unit 1870, and output unit 1875, in some example implementations described above. For example, the flow of one or more processes or implementations may be controlled by logic unit 1860 alone or in conjunction with API unit 1865. The input unit 1870 may be configured to obtain input for the calculations described in the example implementations, and the output unit 1875 may be configured to provide output based on the calculations described in example implementations.

Processor(s) 1810 can be configured to execute a method or computer instructions which can involve analyzing a distance between a first organization and a second organization, the distance being represented by a number of hops between the first organization and the second organization, which may be determined from an organizational graph, as described, for example, with respect to FIG. 5, FIG. 9, and FIG. 11.

Processor(s) 1810 can be configured to execute a method or computer instructions which can involve determining whether a storage volume is eligible for performance sharing based on dynamically adjustable performance metrics comparison the distance, a throughput, a response time, or a throughput limit; in response to the storage volume being eligible for performance sharing, assigning the storage volume to a group of storage volumes, e.g., a QoS group that may be prioritized based on the performance metrics, as described, for example, with respect to FIG. 13.

Processor(s) 1810 can be configured to execute a method or computer instructions which can involve setting one or more configuration parameters for the group of storage volumes based on a relationship between at least two storage volumes within the group of storage volumes, which may be defined by a sum of throughput limits of the at least two storage volumes, as described, for example, with respect to FIG. 14.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. A method for sharing storage performance across volumes based on organizational distance, the method comprising:
analyzing a distance between a first organization and a second organization within an organizational hierarchy, the distance being represented by a number of hops between the first organization and the second organization in an organizational graph, wherein the organizational graph represents relationships between organizational units within an enterprise;
determining whether a storage volume is eligible for performance sharing based on one or more performance metrics comprising at least one of the distance, a throughput, a response time, or a throughput limit;
in response to the storage volume being eligible for performance sharing, assigning the storage volume to a group of storage volumes; and
setting one or more configuration parameters for the group of storage volumes based on a relationship between at least two storage volumes within the group of storage volumes.

2. The method of claim 1, wherein determining whether the storage volume is eligible for performance sharing comprises identifying the at least two storage volumes and corresponding performance metrics, wherein each storage volume is associated with an organizational structure that comprises at least one of an organization ID, a parent organization ID, or a distance from each organization to a storage device.

3. The method of claim 2, wherein the organizational structure comprising the organizational hierarchy is retrieved from a directory server that comprises at least one of Lightweight Directory Access Protocol (LDAP) or active directory.

4. The method of claim 1, wherein the relationship between the at least two storage volumes is defined by a sum of throughput limits of the at least two storage volumes.

5. The method of claim 4, further comprising, for each storage volume, defining a throughput upper limit, and setting the throughput upper limit of each volume to a value that enables performance sharing when forming the group,
wherein the throughput upper limit of the group is set to a sum of the throughput upper limits of the at least two storage volumes.

6. The method of claim 1, wherein the number of hops is determined from an organizational graph.

7. The method of claim 1, wherein setting the one or more configuration parameters comprises adjusting Quality of Service (QoS) configurations in a management table to enable performance sharing among the volumes.

8. The method of claim 1, wherein at least one of the one or more performance metrics or the one or more configuration parameters is dynamically adjustable.

9. The method of claim 1, wherein the group of storage volumes is a quality of service (QoS) group.

10. The method of claim 1, wherein the group of storage volumes is prioritized based on at least some of the one or more performance metrics.

11. The method of claim 1, further comprising monitoring storage devices to determine associated storage volumes that exceed their throughput or capacity thresholds, and prioritizing storage volumes that exceed their throughput upper limit for grouping.

12. The method of claim 11, further comprising selecting a storage device for creating a new storage volume based on performance and capacity thresholds for the storage device, and based on a distance between a user's organization and a representative organization of the storage device, wherein the throughput or capacity thresholds are stored in a storage device management table.

13. The method of claim 1, further comprising, in response to the storage volume exceeding its performance threshold, outputting a recommendation for a potential group for performance sharing.

14. The method of claim 1, further comprising grouping storage volumes for performance sharing if the volumes are associated with a same organizational unit, as specified in an organizational management table.

15. The method of claim 14, wherein storage volumes belonging to the same organizational unit or division are prioritized for inclusion in a same QoS group.

16. The method of claim 1, wherein storage devices are sorted based on their proximity to an organization associated with the storage volume being created, using distance data from a user management table.

17. The method of claim 1, wherein storage volumes are automatically removed from the group of storage volumes based on a periodic check determining that no volume in the group has reached a contract-defined throughput upper limit within a predefined time period.

18. The method of claim 1, further comprising using a management UI to manually modify the group of storage volumes to include or exclude specific storage volumes.

19. A non-transitory computer-readable medium for storing instructions for executing a process, the instructions comprising:
analyzing a distance between a first organization and a second organization within an organizational hierarchy, the distance being represented by a number of hops between the first organization and the second organization in an organizational graph, wherein the organizational graph represents relationships between organizational units within an enterprise;
determining whether a storage volume is eligible for performance sharing based on one or more performance metrics comprising at least one of the distance, a throughput, a response time, or a throughput limit;
in response to the storage volume being eligible for performance sharing, assigning the storage volume to a group of storage volumes; and
setting one or more configuration parameters for the group of storage volumes based on a relationship between at least two storage volumes within the group of storage volumes.

20. An apparatus, comprising:
a processor, configured to:
analyze a distance between a first organization and a second organization within an organizational hierarchy, the distance being represented by a number of hops between the first organization and the second organization in an organizational graph, wherein the organizational graph represents relationships between organizational units within an enterprise;
determine whether a storage volume is eligible for performance sharing based on one or more performance metrics comprising at least one of the distance, a throughput, a response time, or a throughput limit;
in response to the storage volume being eligible for performance sharing, assign the storage volume to a group of storage volumes; and
set one or more configuration parameters for the group of storage volumes based on a relationship between at least two storage volumes within the group of storage volumes.
